(19) United States
(12) Patent Application Publication
(10) Pub. No.: US 2003/0180704 A1
(43) Pub. Date: Sep. 25, 2003

(54) Ice-controlling molecules and uses thereof

(76) Inventors: Kelvin G.M. Brockbank, Charleston, SC (US); Michael J. Taylor, Mount Pleasant, SC (US); Bijan S. Khirabadi, Rockville, MD (US); Ying C. Song, Mount Pleasant, SC (US)

Correspondence Address: OLIFF & BERRIDGE, PLC, P.O. BOX 19928, ALEXANDRIA, VA, 22320, US

(21) Appl. No.: 10/099,943

(22) Filed: Mar. 19, 2002

(51) Int. Cl. A01N 1/00; A01N 1/02

(52) U.S. Cl. 435/1.3

(57) ABSTRACT

Preferred ice-controlling materials have been found to include 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives of the ice-controlling materials that include one or more charged moieties therein, and polymers including one or more of the ice-controlling materials in the chain thereof. Use of these ice-controlling materials in methods of inhibiting growth of ice crystals, including both cryopreservation and industrial applications such as within gas pipelines, is advantageous.

### BACKGROUND OF THE INVENTION

1. Field of Invention

This invention pertains to a preferred class of ice-controlling materials that bind to ice and inhibit or substantially prevent growth of ice crystals, and to methods of substantially preventing the formation of ice crystals utilizing such ice-controlling materials. The ice-controlling materials may be used in the field of cryopreservation as well as in other fields such as, for example, in substantially preventing the formation of ice inside of pipelines.

2. Description of Related Art

Ice formation is damaging in many fields. For example, ice formation is very damaging to living systems and food products. Ice formation is a particular problem in the field of cryopreservation in which living cells and organs may be extensively damaged and/or destroyed if ice crystals form during the cryopreservation process. Ice formation is also a problem in other industrial settings, for example including in the field of gas transportation through pipelines. If ice crystals form and agglomerate within the pipeline, gas flow through the pipeline is diminished or ceases altogether, requiring expensive procedures to be undertaken to remove the ice from the pipeline and restore gas flow.

Several natural molecules exist that alter the behavior of ice and of water. Antifreeze glycoproteins (AFGPs) and antifreeze proteins or antifreeze peptides (AFPs) produced by several species of fish are believed to adsorb preferentially to the prism face of ice and thus to inhibit ice crystal growth perpendicular to the prism face.

This capability is sufficient to permit certain fish to live their entire lives at a body temperature about 1° C. below the thermodynamic freezing point of the fishes' body fluids. These fish can ingest and contact ice crystals that might otherwise provide crystal nucleation sites without being invaded by the growth of ice through their supercooled tissues because the AFGPs present in their tissues and body fluids block ice growth despite the presence of supercooling. Insect antifreeze or “thermal hysteresis” proteins (THPs) are even more effective, being active at supercooling levels of 2° C. or more below the thermodynamic freezing point.

The natural “antifreeze” or “thermal hysteresis” proteins found in polar fish and certain terrestrial insects are believed to adsorb to ice by lattice matching (Davies and Hew, FASEB J., 4; 2460-2468, 1990) or by dipolar interactions along certain axes (Yang, Sax, Chakrabartty and Hew, Nature, 333:232-237, 1988).

AFGPs and AFPs found in certain organisms provide natural “proofs of principle” for the concept of novel man-made ice-controlling materials (or ice interface dopants, i.e., IIDs). However, natural ice interface doping proteins are not sufficiently active or abundant for most practical applications of interest. Furthermore, a disadvantage of growth inhibition on the prism faces is that, when supercooling becomes sufficient to overcome ice crystal growth inhibition, growth occurs, by default, predominantly in the direction of the c axis, perpendicular to the basal plane. This results in the formation of spicular or needle-shaped ice crystals that are more damaging to living cells than normal ice, apparently for mechanical reasons.

Natural IIDs are commercially available only in a very limited quantity and variety. Furthermore, they must have fairly high relative molecular masses (typically at least about 4,000 daltons) to be effective. This tends to make them expensive, and they often require complex interactions with other hard-to-acquire proteins and often require carbohydrate moieties for full effectiveness. Insect antifreeze proteins, recently shown to be extremely effective compared to fish antifreeze proteins, still have relative molecular masses of around 8,400 daltons. (Graham, Liou, Walker and Davies, Nature, 388:727-728, 1997).

Furthermore, addition of natural fish AFGP to a concentrated solution of cryoprotectant (30-40% v/v DMSO) had minimal effect on ice crystal growth rates below −20 to −40° C. (Fahy, G. M., in Biological Ice Nucleation and its Applications, chapter 18, pp. 315-336, 1995), thus making questionable its effectiveness for use in organ vitrification for cryopreservation.

Another problem with natural antifreeze proteins is that continuing confusion over their precise mechanisms of action hampers the development of recombinant variants that could be more effective. Recently, Warren and colleagues reported some progress in this direction (U.S. Pat. No. 5,118,792).

Caple et al. (Cryo-Letters, 4:51-58, 1983) made several apparently arbitrary synthetic polymers and showed that some of them were able to prevent nucleation of water by silver iodide crystals. They suggested that these polymers adsorbed either to the silver iodide or to ice crystal nuclei, but they did not suggest any specific interactions, and their polymers were made without regard to any consideration of the structure of ice or of AgI. Further, except for noting that a 2 to 1 ratio of hydrophobic to hydrophillic groups on their polymers gave maximum inhibition of nucleation, they provided no guidance or general principles as to how one could approach the synthesis of ice-binding polymers on a systematic theoretical or empirical basis or maximize the ice-binding effectiveness of such polymers. They also taught that higher concentrations of their polymers nucleated their solutions, and failed to teach that their polymers would slow ice crystal growth rates or have other than academic uses. Caple et al. (Cryo-Letters, 4: 59-64, 1983) also reported detecting unidentified, uncharacterized, and unpurified nucleation-inhibiting substances from natural sources, but again suggested no applications.

The concept of designing specific artificial chemical agents whose purpose is to control the physics of ice was first mentioned by Fahy in Low Temperature Biotechnology, McGrath and Diller, eds., ASME, pp.113-146, 1988. The sole mention of this idea was the single statement that “insight into the mechanism of AFP action . . . opens the possibility of designing molecules which may be able to inhibit ice crystal growth in complementary ways, e.g., along different crystallographic planes.” However, no method of preparing such molecules was suggested.

Kuo-Chen Chou (“Energy-optimized structure of antifreeze protein and its binding mechanism”, J. Mol. Biol., 223:509-517, 1992) mentions an intention to specifically design ice crystal growth inhibitors. However, it is confined to minor modifications of existing antifreeze molecules.

Based on these observations, it is advantageous to design materials that can inhibit ice crystal growth preferably and specifically in the direction of the c axis in accordance with the present invention. When also able, or used in combination with an agent acting, to block growth in the direction of the basal plane, such that all growth planes would be inhibited rather than only one, such materials should avoid the lethal drawbacks of the prior art of freezing cells using only basal plane growth inhibitors. Furthermore, since growth in the direction of the c axis, hereinafter “C growth,” is the limiting factor for supercooling in the presence of agents that adsorb to the prism face (agents that block growth in the a axis direction, or “A growth”), C growth inhibitors should enhance supercooling considerably over the supercooling achievable with A growth inhibitors alone when used in combination with A growth inhibitors.

A problem with natural antifreeze proteins has been continuing confusion over their precise mechanisms of action. Recently, Sicheri and Yang (Nature, 375:427-431, 1995) described a clear model of how AFPs undergo lattice matching with ice. They indicated that, of 8 AFPs examined, the number of ice-binding atoms ranged from 3 to 10 per AFP and that each AFP formed, on average, ice contacts at between 1 in every 4.8 to 1 in every 15 amino acids present in the molecule (roughly 1 ice bond per 422-1340 daltons of AFP mass). The ice-binding amino acids were threonine (thr), aspartate (asp), asparagine (asn), and lysine (lys). Each binding amino acid formed one bond per amino acid and the bonds were formed by the hydroxyl oxygen of thr, the amino nitrogen of lys and of asn, and the acid oxygen (O⁻ or carbonyl O) of asp. For the winter flounder AFP, detailed analysis showed that the lattice matching depended on a planar arrangement of the AFP's bonding groups and on geometrical constraints on the freedom of motion of the matching groups. Bonding took place on the ridges of the 2021 plane (Biophys. J., 63:1659-1662, 1992; Faraday Discuss., 95:299-306, 1993; J. Am. Chem. Soc., 116:417-418, 1994.) More detailed analysis showed that the lattice match between asn and asp oxygen and nitrogen and ice oxygens was imperfect. For one thing, the oxygens in ice associated with these sites were located to the side of each binding atom, not directly underneath. For another, the trigonal planar (sp2) coordination of the hydrogen-bonding groups of asn and asp differ from the tetrahedral (sp3) coordination of oxygens in ice. They concluded that “the underlying hydrogen-bonding interactions are likely to be more liberally defined than previously proposed” by other authors (Biophys. J., 59: 409-418, 1991; Biophys. J., 63: 1659-1662, 1992; Biophys. J., 64: 252-259, 1993).

O'Connell et al. “Cryoprotectants for Crithidia fasciculata Stored at −20 C, with Notes on Trypanosoma gambiense and T. conorhini'” The Journal of Protozoology, 15, 4:719-724 (November, 1968) describes testing several potential cryoprotectants in different media for the ability to cryopreserve Crithidia fasciculata without toxicity, and described glycerol as the best cryoprotectant with 1,2,4-butantriol, 1,4-cyclohexanediol, dimethylsulfoxide, propylene glycol and N-acetylethanolamine as potential outstanding cryoprotectants. In the summary of the results, it is reported that 1,3-cyclohexanediol is toxic to the Crithidia fasciculata (it killed the sample), and thus is not a cryoprotectant. It is also significant to note that the protozoa evaluated are non-mammalian, and thus the results summarized in O'Connell et al. are of little use in predicting or suggesting use of the materials mentioned therein as cryoprotectants for mammalian systems.

Besides within living systems, ice formation also is a major problem in the field of gas transportation within pipelines. If the gas within the pipeline is within sufficiently cold environments, for example as may be experienced most often in offshore drilling operations, gas hydrates may form within and stop the flow of gas through the pipeline. See Argo et al., “Commercial Development of Low-Dosage Hydrate Inhibitors in a Southern North Sea 69 km Wet-Gas Subsea Pipeline,” SPE Prod. & Facilities, 15 (2):130-134, May, 2000, explaining that gas hydrates are ice-like crystalline solids composed of cages of hydrogen-bonded water molecules surrounding “guest” hydrocarbon gas molecules, and pose a major concern in oil and gas production. Presently, the problem of gas hydrate formation is presently predominantly addressed by pipeline insulation or warming methods or by introducing solvents such as methanol or monoethylene glycol into the pipeline. However, as explained in the article, these methods are very expensive and, in the case of solvent use, becoming impractical from a safety and environmental standpoint. The article also explains that the search for suitable, low-cost, effective hydrate inhibitors is on going.

Thus, derivation of ice-controlling materials that are non-toxic to living systems and thus are suitable for use in cryopreservation, and also that are preferably suitable for use in industrial applications, is still desired.

### SUMMARY OF THE INVENTION

The present invention, in embodiments, relates to a method of inhibiting growth of ice crystals, comprising identifying a material requiring inhibition of growth of ice crystals, and applying to the material, in an amount effective for inhibiting ice crystal growth on or in said material, one or more ice-controlling materials selected from the group consisting of 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives, e.g., charged analogs, of the aforementioned materials, and polymers including one or more of the aforementioned ice-controlling materials in the chain thereof.

In further embodiments, the invention relates to a method of inhibiting growth of ice crystals during cryopreservation of a living system, comprising bringing the living system into contact with a cryopreservation composition containing one or more ice-controlling materials selected from the group consisting of 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives, e.g., charged analogs, of the aforementioned materials, and polymers including one or more of the ice-controlling materials in the chain thereof, and subsequently reducing the temperature of the living system to a cryopreservation temperature.

In still further embodiments, the invention relates to a cryopreservation composition comprising at least one ice-controlling material selected from the group consisting of 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives, e.g., charged analogs, of the aforementioned materials, and polymers including one or more of the ice-controlling materials in the chain thereof.

And in still further embodiments, the invention relates to a method of inhibiting growth of ice crystals within a gas pipeline, comprising introducing into the gas within the gas pipeline one or more ice-controlling materials selected from the group consisting of 1,3,5-cyclohexanetriol, 1,3-cyclohexanediol, 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives, e.g., charged analogs, of the aforementioned materials, and polymers including one or more of the ice-controlling materials in the chain thereof.

### DETAILED DESCRIPTION OF PREFERRED EMBODIMENTS

The present inventors have undertaken extensive study into the formation of ice crystals and into materials that act to control, and preferably substantially prevent, the formation of ice crystals in various settings, in particular in living systems, for example during cryopreservation. These studies have included identifying various potential ice-controlling materials following the procedures described in each of U.S. patent applications Ser. Nos. 08/413,370 and 08/485,185, each incorporated herein by reference in their entirety, and evaluating such materials for ice-controlling properties.

Having followed the procedures outlined in the aforementioned applications and undertaken extensive examination of many potential ice-controlling molecules over the past several years, the inventors have now identified a set of synthetic ice-controlling materials that may be effective in substantially preventing the formation of ice crystals in a variety of settings, including in both living systems (e.g., cryopreservation) and in industrial applications (e.g., prevention of gas hydrate formation in pipelines). These studies have thus resulted in the subject matter of the present invention.

The ice-controlling materials, also referred to herein as IIDs, are preferably capable of binding to any crystallographic plane of ice desired whatever, or even to non-crystallographic patterns inherent in the ice crystal structure. Preferably, the IIDs specifically to bind to at least the basal plane so as to prevent C growth.

The ice-controlling materials of the invention enhance supercooling considerably over the supercooling achievable with A growth inhibitors alone and should also reduce freezing injury by preventing ice crystals from growing to large sizes during cooling as well as by preventing ice crystals from coalescing during warming, a process variously referred to as grain growth, recrystallization, or Ostwald ripening. Excessive growth of ice crystals is thought to be the primary means by which freezing damages the delicate extracellular structures present in organized tissues and organs and leads to the failure of these tissues and organs after thawing. Thus, the invention provides superlative control of ice crystal size and stability during cooling and warming, and provides an alternative approach to vitrification for the cryopreservation of complex systems, achievable with dramatically less technical complexity.

The ice-controlling materials inhibit, and preferably substantially prevent, ice crystal formation. The materials effectiveness in inhibiting and/or substantially preventing ice crystal growth may be readily confirmed through a routine test of associating the material with water molecules, for example via mixing, and then lowering the temperature of the water molecules to observe if ice crystals form. Any other suitable evaluation known in the art may also be used.

Of course, if the ice-controlling material is to be used in inhibiting or preventing ice crystal growth in living systems, i.e., to be used in cryopreservation, the ice-controlling material must also be substantially non-toxic to the living system with which it is to be used. Toxicity among different ice-controlling molecules is not readily or easily predicted. However, it is well within the skill of practitioners in the art to subject a given ice-controlling material to any suitable, known routine evaluation to determine if the ice-controlling material is toxic to a specific living system. For example, a cell sample of the living system to be cryopreserved may be placed in association with the ice-controlling molecule, frozen and then re-warmed under typical cryopreservation conditions, and then the cells evaluated for activity. Such evaluations can determine, without undue experimentation, those ice-controlling molecules that not only inhibit and preferably substantially prevent ice crystal formation, but that are also non-toxic to a given living system and thus may be used in cryopreservation procedures of such living system.

However, even materials that are toxic to some extent to a living system may still be used in cryopreservation of the living system. For example, additional materials that inhibit or mask the toxicity of the ice-controlling material may be included in the cryopreservation solution, thereby enabling the ice-controlling material to still be used in cryopreservation. For example, inclusion of additional materials that prevent the ice-controlling molecule from permeating the cellular membrane, i.e., from entering the intracellular compartment and instead remaining in the extracellular space, can be effective in this regard. Also, a cryopreservation protocol may be followed in which the exposure to the toxic ice-controlling molecule before and after freezing is minimized may also permit the use of such material in cryopreservation as the potentially toxic material may not be able to have any time to permeate the intracellular compartment and kill the biological cell.

A still further possibility is to increase the molecular weight of the ice-controlling material so that it is unable to permeate into the intracellular compartment, because the higher molecular weight renders it far more difficult for the material to cross the cellular membrane, but still possesses the requisite ability to inhibit ice crystal formation. This may be done most preferably by forming the molecule into a linked chain of molecules, e.g., into a polymer with the ice-controlling molecule forming a repeating unit within the chain of the polymer, by any method known in the art of polymer formation, including utilizing a linking group to link the ice-controlling molecules together in the polymer chain.

Still further, the ice-controlling molecules may be modified to include therein a charged side branch or moiety. Such a charged derivative or analog of the ice-controlling molecules can also be effective in preventing the ice-controlling molecule from permeating the cellular membrane, i.e., from entering the intracellular compartment and instead remaining in the extracellular space. Any suitable charged moiety may be added into the molecule without limitation. The charged moiety may thus be added as an additional group within the molecule. Further, the charging group should obviously also most preferably be substantially non-toxic to a biological system that is to be cryopreserved. The use of charged derivatives of the ice-controlling molecules can thus also be effective in rendering useable an otherwise toxic cryoprotectant ice-controlling molecule.

Preferred Example Ice-Controlling Materials

From the foregoing, the inventors have determined a preferred set of synthetic ice-controlling materials for use in both cryopreservation and industrial applications. Specifically, the ice-controlling materials (IIDs) of the present invention are preferably selected from among one or more of 1,4-cyclohexanediol (cis, trans or racemic mixture thereof), 1,2-cyclohexanediol (cis, trans or racemic mixture thereof), 1,3-cyclohexanedione, 1,4-cyclohexanedione, 1,2-cyclohexandione, 1,4-cyclohexanedimethanol, charged derivatives of the ice-controlling materials that include a charged moiety therein, and polymers including one or more such IIDs in the chain thereof. If 1,4-cyclohexanediol is selected as an IID, it is preferably used in combination with one or more additional IIDs, including with 1,3,5-cyclohexanetriol and 1,3-cyclohexanediol, most preferably in combination with 1,3-cyclohexanediol. In certain applications, pyridinium salt might also be used as an effective ice-controlling material. For industrial applications, such as in preventing the formation of ice within gas or oil pipelines, 1,3,5-cyclohexanetriol and 1,3-cyclohexanediol might also be included as ice-controlling materials.

These compounds possess the most preferred bond angles and distances for binding to ice crystals and thereby inhibiting, preferably substantially preventing, their formation and growth.

To verify the ability of these materials to bind to ice crystals and inhibit ice crystal formation., tests were conducted with concentrations up to 0.5 M (6%) of some of these IIDs added to different cryoprotectant mixtures. For reference, two cryoprotectant mixtures were selected as controls. The first, VS55, is a vitrification solution that contains a total concentration of cryoprotectants (dimethyl sulfoxide (DMSO), 1,2-propanediol and formamide) of 8.4 M, and vitrifies completely when cooled at slow rates (˜3-5° C./min). V49 is a diluted version of VS55, containing the same proportional mix of CPAs but at a total concentration of 7.5 M, and freezes readily when cooled slowly (<3° C./min) below −34° C.

Table 1 shows mean (±SEM) data for ice crystallization measurements derived from bulk freezing experiments in which 75 ml of the test solution is placed in a Plexiglas freezing chamber to permit the observation of ice nucleation and growth. The relative activity of a range of potential synthetic ice blocking materials was evaluated by incorporating them at a concentration of 6% in the V49 solution. It was observed that the V49 solution without added solutes froze extensively under these conditions producing an indefinite number of ice crystals that occupied the entire area of the freezing chamber. In marked contrast, the VS55 solution consistently showed the formation of a number of very small ice crystals when cooled to −100° C. at ˜1.5° C./min, but this restricted ice formation occupied only ˜1% of the total area of the bulk sample. These conditions of cooling thus provided a critical evaluation of the tendency to freeze in bulk samples of solutions containing high concentrations of cryoprotectants.

TABLE 1
Bulk Phase Ice Crystallization Measurements from Image Analysis

| Cryoprotectant Solution | Ice Crystal No. | Total Area % |
|---|---|---|
| V49 (7.5 M CPAs) | Indefinite | 100 |
| VS55 (8.4 M CPAs) | 45.7 ± 5.8 (27) | 1.21 ± 0.12 (27) |
| V49 + NaCl | 609 ± 104 (3) | 22.2 ± 1.0 (3) |
| V49 + Sucrose | 5.3 ± 2(3) | 99.8 ± 0.1(3) |
| V49 + 1,2-Cyclohexanedione | 107 ± 23 (2) | 3.6 ± 0.2 (2) |
| (1,2 CHO) | | |
| V49 + 1,3-Cyclohexanedione | 12.5 ± 8.5 (2) | 0.32 ± 0.27 (2) |
| (1,3 CHO) | | |
| V49 + 1,2-Cyclohexanediol | 108 ± 55 (3) | 2.16 ± 0.7 (3) |
| (1,2 CHD) | | |
| V49 + 1,3-Cyclohexanediol | 173 ± 76 (4) | 2.27 ± 0.7 (4) |
| (1,3 CHD) | | |
| V49 + 1,4-Cyclohexanediol | 107 ± 66 (5) | 1.68 ± 0.55 (5) |
| (1,4 CHD) | | |
| V49 + 1,3 CHD and 1,4-CHD | 31.3 ± 8.1 (3) | 0.54 ± 0.07 (3) |

Values are the Mean ± SEM (n).

Table 1 shows that all solutions, with the exception of V49+sucrose, produced significantly less p<0.001) ice than the V49 solution alone. Measurements of ice crystal number and the total area occupied by ice should not be considered independently because some solutions such as V49+ sucrose appear to produce a very high percentage of ice from a few nucleation sites, compared with the VS55 control vitrification medium that yields only 1.2% total ice from 46±6 nucleation sites.

One possible analysis of the results is that slow cooling of a vitrification medium under these conditions can result in the formation of ice nuclei but these do not grow during the cooling phase. By contrast, fewer nucleation sites in V49+ sucrose appear to grow more rapidly during cooling such that almost complete freezing has occurred by −100° C.

It is noteworthy that all of the synthetic ice-controlling compounds were highly effective in reducing the amount of ice formation and resulted in significantly less ice than either the V49 solution alone, or V49+sucrose (p<0.001). Clearly, the synthetic molecules used individually, or in combination, are more effective than the same percentage concentration of other solutes such as sodium chloride or sucrose used as alternative solutes having a high colligative function and, in the case of sucrose, also regarded as a good glass forming agent.

As discussed at several points above, the preferred IID molecules of the present invention may also be used not only in their base compound form, but may also be used in polymeric form or as charged derivatives/analogs of the molecules. The polymer forms preferably include one or more of the IID molecules in the chain thereof with sufficient frequency such that the polymer still possesses the ice binding and ice crystal formation inhibiting function of the molecules. Any polymer form, linked in any manner in the chain and having any desired molecular weight, may be used without limitation in this regard so long as the aforementioned function criteria are substantially satisfied.

The selection of specific IIDs will depend on the particular application at hand, and many applications of IIDs are envisaged.

Use in Cryoprotection

Each of the above-identified preferred ice-controlling materials is ideally suited for use as a cryoprotectant for living systems small (e.g. cells) and large (e.g., organs) in that not only do the materials inhibit and/or prevent formation and/or growth of ice crystals during vitrification, each also is substantially non-toxic to most living systems and/or can be used in such a manner as explained above that avoids any toxicity effects of the material to the living system.

Cryopreservation, i.e., the preservation of cells by freezing, in the present invention may be effected using the preferred ice-controlling materials in any conventional manner. By “freezing” as used herein is meant temperatures below the freezing point of water, i.e., below 0° C. Cryopreservation typically involves freezing cells to temperatures well below freezing, for example to −130° C. or less. The cryopreservation temperature should be less than −20° C., more preferably −80° C. or less, most preferably −130° C. or less.

The living system that may be cryopreserved using the ice-controlling materials of the invention may be in suspension, may be attached to a substrate, etc., without limitation.

In the method of the invention, the system to be protected during cryopreservation is first brought into contact with a cryopreservation composition. By being brought into contact with the cryopreservation composition is meant that the system is made to be in contact in some manner with the cryopreservation composition so that during the reduction of temperature to the cryopreservation temperature, the cells are protected by the cryopreservation composition. For example, the system may be brought into contact with the cryopreservation composition by filling the appropriate wells of a plate to which living cells to be protected are attached, by suspending the cells in a solution of the cryopreservation composition, etc.

The system to be cryopreserved should also preferably be in contact with freezing compatible pH buffer comprised most typically of at least a basic salt solution, an energy source (for example, glucose) and a buffer capable of maintaining a neutral pH at cooled temperatures. Well known such materials include, for example, Dulbecco's Modified Eagle Medium (DMEM). This material may also be included as part of the cryopreservation composition.

The cryopreservation composition of the invention contains at least one of the aforementioned preferred IID materials. Preferably, the material is present in the cryopreservation composition in an amount of from, for example, 0.05 to 2.0 M, more preferably from 0.1 M to 1.0 M.

The cryopreservation composition also preferably includes a solution suited for organ storage. The solution can include the buffers discussed above. A solution such as, for example, EuroCollins Solution comprised of dextrose, potassium phosphate monobasic and dibasic, sodium bicarbonate and potassium chloride may be used. A preferred solution is UNISOL available from Organ Recovery Systems.

In a further embodiment of the invention, the cryopreservation composition contains not only the IID material, but also at least one additional cryoprotectant compound. These additional cryoprotectant compounds may include, for example, any of those set forth in Table 10.1 of Brockbank, supra, including, but not limited to, acetamide, agarose, alginate, 1-analine, albumin, ammonium acetate, butanediol, chondroitin sulfate, chloroform, choline, dextrans, diethylene glycol, dimethyl acetamide, dimethyl formamide, dimethyl sulfoxide (DMSO), erythritol, ethanol, ethylene glycol, formamide, glucose, glycerol, α-glycerophosphate, glycerol monoacetate, glycine, hydroxyethyl starch, inositol, lactose, magnesium chloride, magnesium sulfate, maltose, mannitol, mannose, methanol, methyl acetamide, methylformamide, methyl ureas, phenol, pluronic polyols, polyethylene glycol, polyvinylpyrrolidone, proline, propylene glycol, pyridine N-oxide, ribose, serine, sodium bromide, sodium chloride, sodium iodide, sodium nitrate, sodium sulfate, sorbitol, sucrose, trehalose, triethylene glycol, trimethylamine acetate, urea, valine, xylose, etc. This additional cryoprotectant compound is preferably present in the cryopreservation composition in an amount of from, for example, 0.1 M to 10.0 M, preferably 0.1 to 2.0 M.

In a still further embodiment of the invention, the cryopreservation composition includes the IID material, with or without an additional cryoprotectant compound, and also includes an anti-freeze protein/peptide (AFP). AFPs also include anti-freeze glycoproteins (AFGPs) and insect anti-freeze, or “thermal hysteresis” proteins, (THPs). Naturally occurring AFPs are believed to be able to bind to the prism face of developing ice crystals, thereby altering their formation. For the fishes and insects in which these proteins occur, it means a depression of their freezing point so they are able to survive under conditions that would normally cause their body fluids to freeze. Any of the well-known AFPs may be used in the present invention in this regard. See, for example, Sicheri and Yang, Nature, 375:427-431, (1995), describing eight such proteins. Most preferably, the AFP may be, for example, AFPI (AFP type I), AFPIII (AFP type III) and/or AFGP. The AFPs may be present in the cryopreservation composition in an amount of from, for example, 0.01 to 1 mg/mL, more preferably 0.05 to 0.5 mg/mL, of composition, for each AFP present.

Once the system has been contacted with the cryopreservation composition, the system may then be frozen for cryopreservation. The cryopreservation and subsequent warming may be conducted in any manner, and may utilize any additional materials, well known in the art.

The cooling (freezing) protocol for cryopreservation may be any suitable type. Many types of cooling protocols are well known to practitioners in the art. Most typically, the cooling protocol calls for continuous rate cooling from the point of ice nucleation to −80° C., with the rate of cooling depending on the characteristics of the cells/tissues being frozen as understood in the art (again, see Brockbank, supra). The cooling rate may be, for example, −0.1° C. to −10° C. per minute, more preferably between −1° C. to −2° C. per minute. Once the system is cooled to about −80° C. by this continuous rate cooling, it can be transferred to liquid nitrogen or the vapor phase of liquid nitrogen for further cooling to the cryopreservation temperature, which is below the glass transition temperature of the freezing solution (again, typically −130° C. or less).

Once cryopreserved, the cells will subsequently be re-warmed for removal of the cryopreserved system from the cryopreserved state. The warming protocol for taking the cells out of the frozen state may be any type of warming protocol, which are well known to practitioners in the art. Typically, the warming is done in a one-step procedure in which the cryopreserved specimen is placed into a water bath (temperature of about 37-42° C.) until complete re-warming is effected. More rapid warming is also known.

### INDUSTRIAL USES

A substantial industrial use for the preferred IID materials of the present invention may be found in the field of gas or oil pipelines. It has been very difficult to develop materials that prevent the formation and agglomeration of ice and gas hydrates within pipelines because of the unique environment. Specifically, the pipeline may be subjected to extremely cold temperatures, particularly in pipelines used in offshore drilling operations, and may be under large pressures, not to mention that the pipe itself is a small, enclosed compartment with many surface imperfections ideal for ice and gas hydrate formation. Surprisingly, the IID materials of the invention may inhibit formation and agglomeration of such ice crystals and gas hydrates, even within the harsh, enclosed conditions within the pipeline. The IID materials are also environmentally innocuous and do not alter the chemical characteristics of the gas within the pipeline, and thus can be readily used without substantial side effects. The IID materials of the invention may be used to inhibit and/or substantially prevent the formation and/or agglomeration of ice and gas hydrates within the pipeline using conventional techniques of introducing solvents or other gas hydrate inhibitors into the pipeline (see, e.g., Argo et al., supra) or into the material to travel through the pipeline. Also, the amount of IID materials introduced may be of any amount without restriction, and including amounts similar to the amounts of solvents and/or gas hydrate inhibitors presently in use in the art.

By preventing Ostwald ripening, IIDs can, for example, prevent frozen foods such as frozen vegetables from sticking firmly together in the household freezer.

IIDs retard ice growth by physically blocking a fraction of the ice crystal surface and by effectively increasing the surface energy (increasing the evaporation rate) of ice near but not beneath the IID. The more area covered by the IID, the more ice surface will be available to participate in sublimation. Thus, paradoxically, use of an IID, which is often considered to increase ice surface energy (thus inhibiting crystal size increase) can also produce a net reduction in crystal sublimation rate (thus inhibiting crystal size decrease). Therefore, freezer burn in steaks and other products can be slowed, and slowed sublimation or melting of the polar ice caps in response to global warming could be attempted. For such uses, the IID may simply be coated on the materials that are or are to be frozen.

By preventing coalescence of small ice particles in ice cream and similar products, the storage life of such products can be extended by months, and the ice cream itself will be somewhat softer at household freezer temperature than conventionally produced ice cream without using the enormous sugar concentrations required by the FreezeFlo process, for example. For this purpose, an effective amount of the IID may be mixed with the product, preferably before packaging of the product.

By preventing seed crystals from nucleating supercooled water on crops such as citrus crops, millions of acres of agricultural products (e.g., all Florida orange groves) can be prevented from freezing on an annual basis, much more reliably and effectively than can be achieved via application of Frostban, a bacterium that simply lacks a nucleating site on its membrane. For this purpose, the IID may be coated on the crops, for example by spraying.

IIDs can also be utilized to stabilize formed ice crystals. For example, they can be used in the snowmaking industry to stabilize previously formed snowflakes to attain a longer-lasting “powder” for skiers' enjoyment. In this application, IIDs can be sprayed onto snow flakes as they are created. This will prevent recrystallization (coalescence) and sublimation (causing shape change) of the snow flakes.

IIDs also have important applications in the prevention of or removal of now-troublesome icing of automobiles, aircraft, rocket boosters, and similar equipment, and in the removal or safe navigation of icing on roadways. They can be incorporated, for example, into the substance and/or treads of tires, shoes, and mountain-climbing aids so that cars, people and other objects will not slip but will instead actually stick to ice, reducing accidents and injuries due to icy conditions. In this application, weak ice bonding would be used to prevent ice from detaching from the underlying ice, thus fooling the ice-bonding surface. IIDs can coat thin layers of ice on airplane wings and automobile windshields, presenting a greasy surface that will not stick to additional ice, thereby allowing additional deposited ice to simply be wiped or pushed off or to fall off rather than to be chiseled or melted off.

In these different applications, the non-ice bonding surface of the IID may be modified for ease of assimilation into the substrate material during the manufacturing process, or to achieve goals of solubility, texture suitability or of toxicity limitation. Modifications to the non-ice bonding surface will depend on the substrate material and will be apparent to those skilled in the art. Changes in the ice-bonding surface will be made to extend or reduce the ice adhesion strength in a straightforward manner for the application at hand.

While this invention has been described in conjunction with specific embodiments thereof, it is evident that many alternatives, modifications and variations will be apparent to those skilled in the art. Accordingly, the preferred embodiments of the invention as set forth herein are intended to be illustrative only, and not limiting. Various changes may be made without departing from the spirit and scope of the invention as defined in the following claims.

What is claimed is:

1. A method of inhibiting growth of ice crystals, comprising
identifying a material requiring inhibition of growth of ice crystals, and
applying to the material, in an amount effective for inhibiting ice crystal growth on or in said material, one or more ice-controlling materials selected from the group consisting of 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives of the ice-controlling materials that include one or more charged moieties therein, and polymers including one or more of the ice-controlling materials in the chain thereof.

2. The method according to claim 1, wherein the ice-controlling material is a mixture of 1,4-cyclohexanediol and 1,3-cyclohexanediol.

3. The method according to claim 1, wherein the ice-controlling material is a polymer including one or more of the ice-controlling materials in the chain thereof, the ice-controlling materials being present in the chain in an amount effective to inhibit ice crystal growth.

4. The method according to claim 1, wherein the ice-controlling material is a charged derivative of the ice-controlling materials that include one or more charged moieties in the molecules thereof.

5. The method according to claim 1, wherein the material is selected from the group consisting of an ice crystal whose growth is to be prevented, a material within a pipeline, a food product, a living plant, a vehicle surface, a road surface, a walkway, footwear, a light transmitter, a manufactured snow crystal, and a utility line.

6. The method according to claim 5, wherein the material is a gas within a gas pipeline.

7. The method according to claim 5, wherein the food product is a citrus crop or frozen food.

8. The method according to claim 5, wherein the vehicle surface is a windshield or an airplane wing.

9. The method according to claim 1, wherein the material is an organ, body fluid or other body tissue that is to be cooled for cryopreservation.

10. A method of inhibiting growth of ice crystals during cryopreservation of a living system, comprising bringing the living system into contact with a cryopreservation composition containing one or more ice-controlling materials selected from the group consisting of 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives of the ice-controlling materials that include one or more charged moieties therein, and polymers including one or more of the ice-controlling materials in the chain thereof, and subsequently reducing the temperature of the living system to a cryopreservation temperature.

11. The method according to claim 10, wherein the ice-controlling material is present in the cryopreservation composition in an amount of from 0.05 to 2.0 M.

12. The method according to claim 11, wherein the cryopreservation composition further contains at least one additional cryoprotectant compound.

13. The method according to claim 12, wherein the at least one additional cryoprotectant compound is selected from the group consisting of including acetamide, agarose, alginate, 1-analine, albumin, ammonium acetate, butanediol, chondroitin sulfate, chloroform, choline, dextrans, diethylene glycol, dimethyl acetamide, dimethyl formamide, dimethyl sulfoxide (DMSO), erythritol, ethanol, ethylene glycol, formamide, glucose, glycerol, α-glycerophosphate, glycerol monoacetate, glycine, hydroxyethyl starch, inositol, lactose, magnesium chloride, magnesium sulfate, maltose, mannitol, mannose, methanol, methyl acetamide, methylformamide, methyl ureas, phenol, pluronic polyols, polyethylene glycol, polyvinylpyrrolidone, proline, propylene glycol, pyridine N-oxide, ribose, serine, sodium bromide, sodium chloride, sodium iodide, sodium nitrate, sodium sulfate, sorbitol, sucrose, trehalose, triethylene glycol, trimethylamine acetate, urea, valine and xylose.

14. The method according to claim 10, wherein the cryopreservation composition further contains at least one anti-freeze protein.

15. A cryopreservation composition comprising at least one ice-controlling material selected from the group consisting of 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives of the ice-controlling materials that include one or more charged moieties therein, and polymers including one or more of the ice-controlling materials in the chain thereof.

16. The cryopreservation composition according to claim 15, wherein the ice-controlling material is present in the cryopreservation composition in an amount of from 0.05 to 2.0 M.

17. The cryopreservation composition according to claim 15, wherein the at cryopreservation composition further comprises at least one additional cryoprotectant compound selected from the group consisting of acetamide, agarose, alginate, 1-analine, albumin, ammonium acetate, butanediol, chondroitin sulfate, chloroform, choline, dextrans, diethylene glycol, dimethyl acetamide, dimethyl formamide, dimethyl sulfoxide (DMSO), erythritol, ethanol, ethylene glycol, formamide, glucose, glycerol, α-glycerophosphate, glycerol monoacetate, glycine, hydroxyethyl starch, inositol, lactose, magnesium chloride, magnesium sulfate, maltose, mannitol, mannose, methanol, methyl acetamide, methylformamide, methyl ureas, phenol, pluronic polyols, polyethylene glycol, polyvinylpyrrolidone, proline, propylene glycol, pyridine N-oxide, ribose, serine, sodium bromide, sodium chloride, sodium iodide, sodium nitrate, sodium sulfate, sorbitol, sucrose, trehalose, triethylene glycol, trimethylamine acetate, urea, valine and xylose.

18. The cryopreservation composition according to claim 15, wherein the cryopreservation composition further contains at least one anti-freeze protein.

19. A method of inhibiting growth of ice crystals within a pipeline carrying a material therethrough, comprising introducing into the pipeline one or more ice-controlling materials selected from the group consisting of 1,3,5-cyclohexanetriol, 1,3-cyclohexanediol, 1,2-cyclohexanediol, 1,3-cyclohexanedione, 1,4-cyclohexanedione, 1,2-cyclohexandione, 1,4-cyclohexanedimethanol, a mixture of 1,4-cyclohexanediol with one or more of 1,3,5-cyclohexanetriol, 1,3-cyclohexanediol, 1,2-cyclohexanediol, 1,3-cyclohexanedione, 1,4-cyclohexanedione, 1,2-cyclohexandione and 1,4-cyclohexanedimethanol, charged derivatives of the ice-controlling materials that include one or more charged moieties therein, and polymers including one or more of the ice-controlling materials in the chain thereof.

20. The method according to claim 19, wherein the material is a gas or oil.
